(19) United States
(12) Patent Application Publication
(10) Pub. No.: US 2025/0220272 A1
(43) Pub. Date: Jul. 3, 2025

(54) SYSTEMS AND METHODS FOR INCREASING USER ENGAGEMENT WITH CONTENT BEING VIEWED BY THE USER

(71) Applicant: DISH Network L.L.C., Englewood, CO (US)

(72) Inventors: Jared Backofen, Colorado Springs, CO (US); Charles Ray Buckley, Ault, CO (US)

(21) Appl. No.: 18/397,490

(22) Filed: Dec. 27, 2023

(51) Int. Cl. H04N 21/472; G06F 30/12; H04L 9/00

(52) U.S. Cl. CPC H04N 21/472; G06F 30/12; H04L 9/50

(57) ABSTRACT

A system and method for increasing user-engagement with underlying content (e.g., one or more of television and movie programming) being viewed by a user on a display device is disclosed. The method includes: presenting linear streaming or on-demand underlying content to the user on the display device; randomly presenting virtual engagement content that is incorporated into the underlying content for a period of time to the user on the display device; enabling the user to capture, using a remote control device, the virtual engagement content that is incorporated into the underlying content during the period of time by the user on the display device; removing the virtual engagement content that is incorporated into the underlying content after the period of time; and enabling the user to redeem the captured virtual engagement content.

### TECHNICAL FIELD

The present disclosure relates generally to a digital content system and method, and more particularly, but not exclusively, to a system and method for increasing user engagement in viewing content on a digital content system.

### BACKGROUND

While there is a high level of viewership of television and movies at the residences of users, it can be challenging to maintain the engagement of users with a particular television show or movie. There are such a large number of channels and streaming platforms that it can be difficult to prevent users from constantly switching from one program to another program at the slightest sense of dissatisfaction. Additionally, the proliferation of smartphones, tablets, and laptop computers has also resulted in users that turn away from a television show or movie they are watching to check content, notifications, text messages, or emails on their smartphones, tablets, and laptop computers, if the users even momentarily have waning interest in the television show or movie being viewed. Accordingly, there is a continuing need for systems and methods that provide increased user engagement with content being viewed on a digital content system. The present disclosure addresses this and other needs.

### BRIEF SUMMARY

The present disclosure is directed towards a system for increasing user-engagement with underlying content being viewed by a user on a display device. In some embodiments, the memory is arranged to store computer instructions, and the computer instructions are executable by the processor. Accordingly, the computer instructions cause the processor to: present linear streaming or on-demand underlying content to the user on the display device; randomly present virtual engagement content that is incorporated into the underlying content for a period of time to the user on the display device; enable the user to capture, using a remote control device, the virtual engagement content that is incorporated into the underlying content during the period of time; remove the virtual engagement content that is incorporated into the underlying content after the period of time; store the captured virtual engagement content in a virtual library on a server; enable the user to view the captured virtual engagement content the user stored in the virtual library on the server; and enable the user to redeem the captured virtual engagement content.

In some embodiments of the system for increasing user-engagement with underlying content being viewed by a user on a display device, the virtual engagement content is captured by using a fixed button press on the remote control device. In another aspect of some embodiments, the virtual engagement content is captured by using a button press on the remote control device that is specific to the virtual engagement content being captured. In still another aspect of some embodiments, the engagement content is presented at random locations on the display device. In yet another aspect of some embodiments, the virtual engagement content is associated with at least a portion of the underlying content being presented to the user on the display device. Further, in another aspect of some embodiments, the system creates a non-fungible token associated with the virtual engagement content that enables the virtual engagement content to be one or more of traded, sold, and purchased.

In one or more embodiments of the system for increasing user-engagement with underlying content, the memory further includes additional computer instructions, that when executed by the one or more processors, cause the system to: receive a request from the user to 3D print the virtual engagement content; communicate with a server that stores the virtual engagement content that was captured by the user during one or more of television and movie programming; prepare a 3D printer file of the virtual engagement content requested by the user; prevent duplication of the 3D printer file of the virtual engagement content requested by the user; send the 3D printer file of the virtual engagement content to a 3D printer to be printed; and validate authenticity of transformation of the virtual engagement content into a 3D printed tangible physical item. In another aspect of some embodiments, the system creates a non-fungible token associated with the 3D printed tangible physical item that enables the 3D printed tangible physical item to be one or more of traded, sold, and purchased. In still another aspect of some embodiments, the 3D printed tangible physical item is printed with a bar code that when scanned shows the current ownership of the non-fungible token associated with the 3D printed tangible physical item.

Additionally, embodiments described herein are directed towards a method for increasing user engagement with underlying content being viewed by a user on a display device. Some such methods include: presenting linear streaming or on-demand underlying content to the user on the display device; randomly presenting virtual engagement content that is incorporated into the underlying content for a period of time to the user on the display device; enabling the user to capture, using a remote control device, the virtual engagement content that is incorporated into the underlying content during the period of time; removing the virtual engagement content that is incorporated into the underlying content after the period of time; storing the captured virtual engagement content in a virtual library on a server; enabling the user to view the captured virtual engagement content the user stored in the virtual library on the server; and enabling the user to redeem the captured virtual engagement content.

In some embodiments of the method for increasing user-engagement with underlying content being viewed by a user on a display device, the virtual engagement content is captured by using a fixed button press on the remote control device. In another aspect of some embodiments, the virtual engagement content is captured by using a button press on the remote control device that is specific to the virtual engagement content being captured. In still another aspect of some embodiments, the virtual engagement content is presented at random locations on the display device. In yet another aspect of some embodiments, the virtual engagement content is associated with at least a portion of the underlying content being presented to the user on the display device. Further, in another aspect of some embodiments, the method further includes creating a non-fungible token associated with the virtual engagement content that enables the virtual engagement content to be one or more of traded, sold, and purchased.

In one or more embodiments of the method for increasing user-engagement with underlying content, the method further includes: receiving a request from the user to 3D print the virtual engagement content; communicating with a server that stores the virtual engagement content that was captured by the user during one or more of television and movie programming; preparing a 3D printer file of the virtual engagement content requested by the user; preventing duplication of the 3D printer file of the virtual engagement content requested by the user; sending the 3D printer file of the virtual engagement content to a 3D printer to be printed; and validating authenticity of transformation of the virtual engagement content into a 3D printed tangible physical item. In another aspect of some embodiments, the method further includes creating a non-fungible token associated with the 3D printed tangible physical item that enables the 3D printed tangible physical item to be one or more of traded, sold, and purchased. In still another aspect of some embodiments, the method further includes: printing the 3D printed tangible physical item with a bar code that when scanned shows the current ownership of the non-fungible token associated with the 3D printed tangible physical item.

In one or more embodiments, a non-transitory computer-readable storage medium is disclosed having computer-executable instructions stored thereon that, when executed by at least one processor, cause the at least one processor to cause operations to be performed. The operations include: presenting linear streaming or on-demand underlying content to the user on the display device; randomly presenting virtual engagement content that is incorporated into the underlying content for a period of time to the user on the display device; enabling the user to capture, using a remote control device, the virtual engagement content that is incorporated into the underlying content during the period of time; removing the virtual engagement content that is incorporated into the underlying content after the period of time; storing the captured virtual engagement content in a virtual library on a server; enabling the user to view the captured virtual engagement content the user stored in the virtual library on the server; and enabling the user to redeem the captured virtual engagement content.

In some embodiments, the virtual engagement content is captured by using a fixed button press on the remote control device. In another aspect of some embodiments, the virtual engagement content is captured by using a button press on the remote control device that is specific to the virtual engagement content being captured. In still another aspect of some embodiments, the virtual engagement content is presented at random locations on the display device. In yet another aspect of some embodiments, the virtual engagement content is associated with at least a portion of the underlying content being presented to the user on the display device. Further, in another aspect of some embodiments, the operations further include creating a non-fungible token associated with the virtual engagement content that enables the virtual engagement content to be one or more of traded, sold, and purchased.

In one or more embodiments, the operations further include: receiving a request from the user to 3D print the virtual engagement content; communicating with a server that stores the virtual engagement content that was captured by the user during one or more of television and movie programming; preparing a 3D printer file of the virtual engagement content requested by the user; preventing duplication of the 3D printer file of the virtual engagement content requested by the user; sending the 3D printer file of the virtual engagement content to a 3D printer to be printed; and validating authenticity of transformation of the virtual engagement content into a 3D printed tangible physical item. In another aspect of some embodiments, the operations further include creating a non-fungible token associated with the 3D printed tangible physical item that enables the 3D printed tangible physical item to be one or more of traded, sold, and purchased. In still another aspect of some embodiments, the operations further include: printing the 3D printed tangible physical item with a bar code that when scanned shows the current ownership of the non-fungible token associated with the 3D printed tangible physical item.

These features with other technological improvements, which will become subsequently apparent, reside in the details of construction and operation as more fully described hereafter and claimed, reference being had to the accompanying drawings forming a part hereof.

### BRIEF DESCRIPTION OF THE DRAWINGS

The present application will be more fully understood by reference to the following figures, which are for illustrative purposes only. The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

FIG. 1 illustrates the display of television programming being viewed by a user on a display device for which a system for increasing user-engagement with the television programming is implemented.

FIG. 2 illustrates a display of television programming being viewed by a user on a display device for which a system for increasing user-engagement with the television programming is implemented with virtual engagement content shown on the underlying television programming content.

FIG. 3 illustrates a virtual trophy (e.g., a virtual engagement content) captured by a user while the user was viewing underlying content.

FIG. 4 illustrates four virtual trophies captured by a user while the user was viewing underlying content as shown in a virtual library.

FIG. 5 illustrates a perspective view of a 3D printing system to which a 3D printer file of the virtual engagement content is sent to a 3D printer to be printed.

FIG. 6 illustrates a perspective view of 3D printing system that has printed the 3D printer file of the virtual engagement content.

FIG. 7 illustrates a logic flow diagram for a method for increasing user-engagement with television programming being viewed by a user on a display device.

FIG. 8 illustrates a system diagram that describes an example implementation of a computing system(s) for implementing embodiments described herein.

### DETAILED DESCRIPTION

Persons of ordinary skill in the art will understand that the present disclosure is illustrative only and not in any way limiting. Other embodiments and various combinations of the presently disclosed system and method readily suggest themselves to such skilled persons having the assistance of this disclosure.

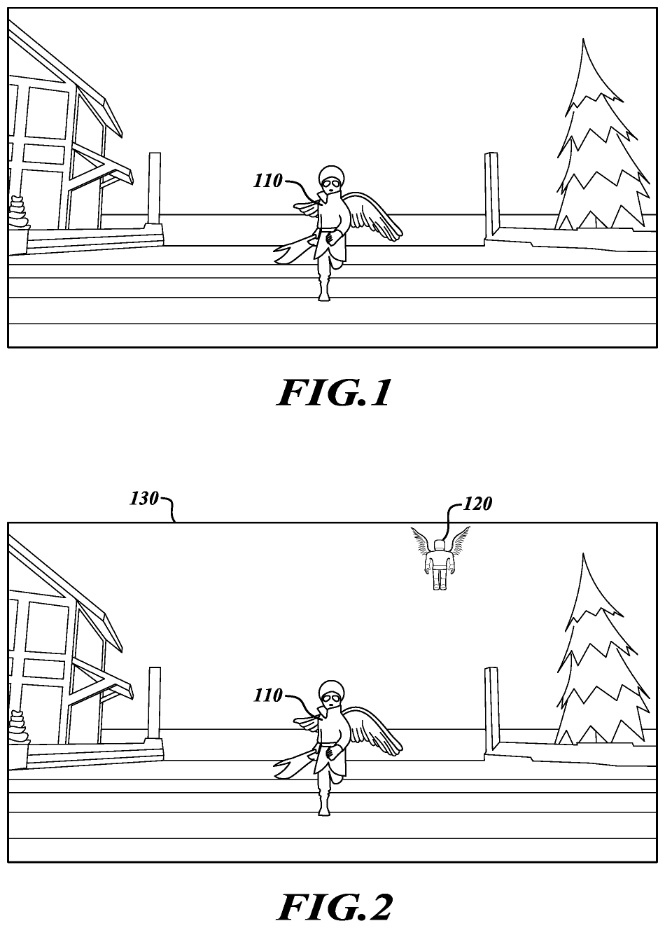

Each of the features and teachings disclosed herein can be utilized separately or in conjunction with other features and teachings to provide a system and method for increasing user-engagement with underlying content (e.g., one or more of television and movie programming, advertising content, or other broadcast content) being viewed by a user on a display device using the insertion of virtual engagement content. Representative examples utilizing many of these additional features and teachings, both separately and in combination, are described in further detail with reference to attached FIGS. 1-8. This detailed description is intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present system and method. However, it will be apparent to one skilled in the art that these specific details are not required to practice the teachings of the present system and method. Also, other methods and systems may be used.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced, but not intended to limit the dimensions and the shapes shown in the examples.

Currently, broadcasters, content developers, and advertisers are all concerned about the lack of engagement by the viewers of television shows and movies. There are several factors causing this lack of engagement by viewers. One factor is that there is such a large number of channels and streaming platforms, it can be difficult to prevent users from constantly switching from program to program. Another factor is the proliferation of various “screens” (e.g., smartphones, tablets, and laptop computers) has resulted in users that turn away from a television show or movie they are watching to check content, notifications, text messages, or emails on their mobile devices.

Referring now to FIGS. 1 and 2, a system for increasing user-engagement with linear streaming television and/or on-demand content 110 (i.e., underlying content) is shown. This underlying content 110 may be advertising segments in some embodiments. In FIG. 1, linear streaming television and/or on-demand content 110 is shown that a user is watching, for which the broadcaster desired to increase engagement.

In FIG. 2, the linear streaming television and/or on-demand content 110 that a user is watching is still shown, but a piece of virtual engagement content 120 is displayed as well. Specifically, in one or more embodiments of the system disclosed in FIG. 2 for increasing user-engagement with linear streaming television and/or on-demand content 110 (i.e., underlying content) being viewed by a user, a random piece of virtual engagement content 120 appears in the upper right hand side of a display device 130 while underlying content 110 is being watched by the user. The random piece of virtual engagement content 120 that appears on the display device 130 is either incorporated into the underlying content 110 or are overlaid on top of the underlying content 110. When the random piece of virtual engagement content 120 appears on the screen of the display device 130, the user has the option to select or capture the virtual engagement content 120 before it disappears after a randomly set amount of time.

In some embodiments, the amount of time the virtual engagement content 120 appears on the screen of the display device 130 is random in that there is not a set period of time that it appears on the screen of the display device 130. In other embodiments, the amount of time the virtual engagement content 120 appears on the screen of the display device 130 is a predefined period of time. In another aspect of some embodiments, the faster a user captures the virtual engagement content 120 when it appears on the screen of the display device 130, the larger the award, compensation, or other enticement that is given to the user that successfully captures the virtual engagement content 120. In this manner, the user's engagement in intensely watching the underlying content 110 is increased so they do not miss the virtual engagement content 120 when it appears on the screen of the display device 130, and so they can capture it as soon as possible after it first appears on the screen.

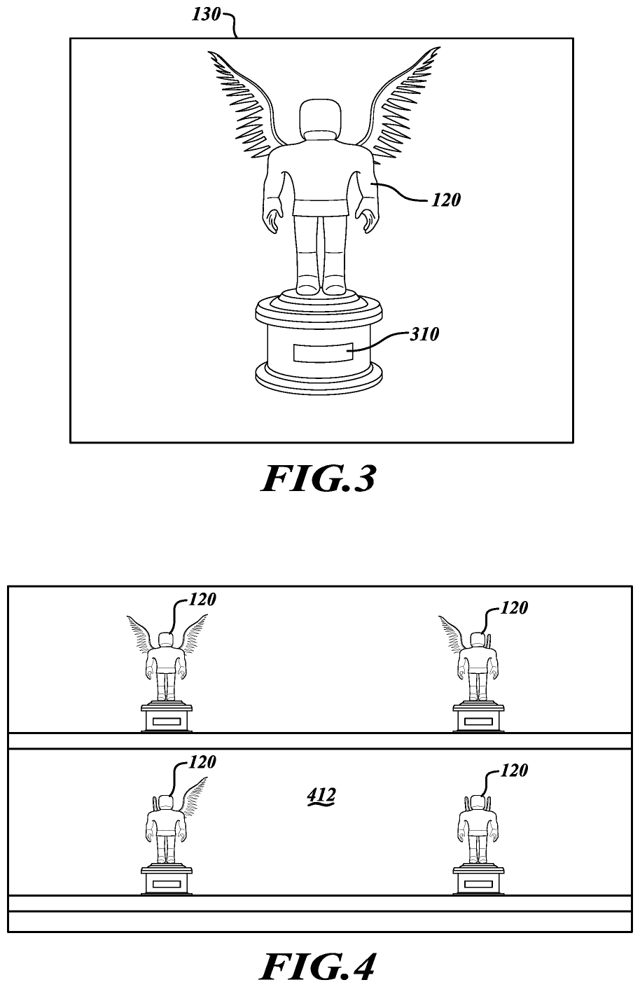

Referring now to FIG. 3, in one embodiment, a piece of virtual engagement content 120 is “captured” with a fixed remote key-press on a remote control device. In another embodiment, a piece of content is “captured” with a randomly chosen key-press that is specified by the virtual engagement content 120 when it appears on the screen of the display device 130. For example, the virtual engagement content 120 shows “12” indicating that the user must press ‘1’ then ‘2’ to capture the digital piece of content. In another example, the virtual engagement content 120 shows “08” indicating that the user must press ‘0’ then ‘8’ to “capture” the virtual engagement content 120. If the user does not capture the virtual engagement content 120 that is incorporated into the underlying content 110 during the designated period of time, then the virtual engagement content 120 is removed from the screen of the display device. In some embodiments, one or more of the date, time, name of the user, and other relevant information 310 related to the capture of the virtual engagement content 120 by the user is shown on the virtual engagement content.

In another aspect of one embodiment of the system for increasing user-engagement with underlying content, the virtual engagement content 120 appears in random locations on the user-interface of the display device 130. By incorporating this randomization of appearance location on the user-interface of the display device 130, it is more difficult for bots (e.g., automated programs) to circumvent this “capturing” process by an active user, and thus, ensure the user is actively engaged. In some embodiments, the user has the option to enable or disable this active engagement feature.

As shown in FIG. 4, after the virtual engagement content 120 is captured by the user, the captured virtual engagement content is stored in a virtual library 412. In various embodiments, the virtual library may be stored on a server, a set-top-box, a user's smartphone (or other mobile computing device), or a user's computer. In one or more embodiments, the captured virtual engagement content 120 is viewable in the virtual library 140 on the server. In some embodiments, these pieces of captured virtual engagement content are Non-Fungible Tokens (NFTs). Non-fungible tokens are blockchain-based tokens each representing a unique asset such as digital content or artwork. A non-fungible token is a digital certificate of ownership and authenticity for a specific asset. Non-fungible tokens are cryptographically verifiable as well as easily transferable. Additionally, the origin and the current owner of the asset can be readily determined by leveraging cryptographic signatures that are native to the blockchain. In other embodiments the pieces of captured virtual engagement content 120 are digital badges, tokens, or stickers.

These NFTs (or badges/tokens/stickers) may be redeemed, traded, or sold for currency (e.g., U.S. dollars) or credits for in-app purchases (e.g., On-Demand content). In one or more embodiments, the pieces of captured virtual engagement content 120 are part of a catalog of digital content that is segmented into collections and sets of collectable virtual engagement content 120. In one aspect of some embodiments, the system for increasing user-engagement with underlying content creates rewards or other incentives (e.g., achievements/titles, credits, currency, prizes, etc.) that may be “redeemed” by capturing a single piece of virtual engagement content 120 or for capturing and completing a collection or set of collectable virtual engagement content 120. In this manner, “redeeming” may be defined as turning in a captured piece of virtual engagement content 120 or turning in a captured collections of piece of virtual engagement content 120 for money, rewards, credits, discounts, points, awards, or other incentives.

In one embodiment, a single television program or movie may have a set of collectable virtual engagement content 120 that appear all throughout the single television program or movie. In such an embodiment, the user may have to capture the entire set of collectable virtual engagement content 120 shown throughout the single television program or movie to show that they were fully engaged through the entire television program or movie. In another embodiment, the user may have to capture the entire set of collectable virtual engagement content 120 shown throughout an entire season of a television program to show that the user was fully engaged through the entire season of the television program. In another aspect of some embodiment, the system for increasing user-engagement with underlying content includes a digital marketplace that enables users to buy/sell/trade the virtual engagement content 120.

This system for increasing user-engagement with underlying content helps facilitate a user being actively engaged in viewing the displayed underlying content 110. In another aspect of some embodiments, this system for increasing user-engagement with underlying content is able to enhance On-Demand purchases if specific pieces of virtual engagement content 120 only appear on certain On-Demand assets (e.g., movies/shows). Furthermore, this system for increasing user-engagement with underlying content improves user satisfaction by adding an enticing “collectables game” to the viewing experience.

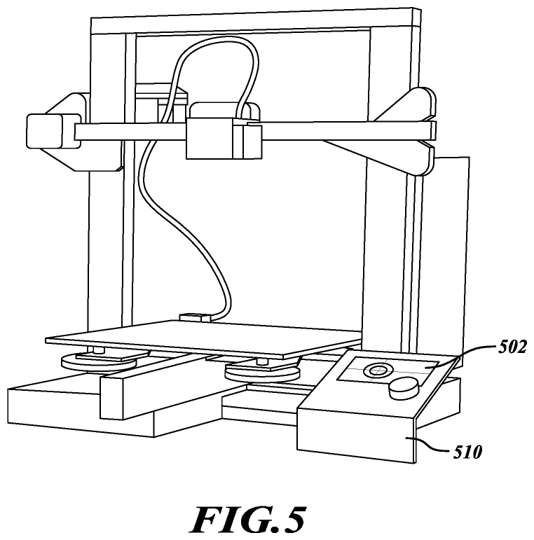

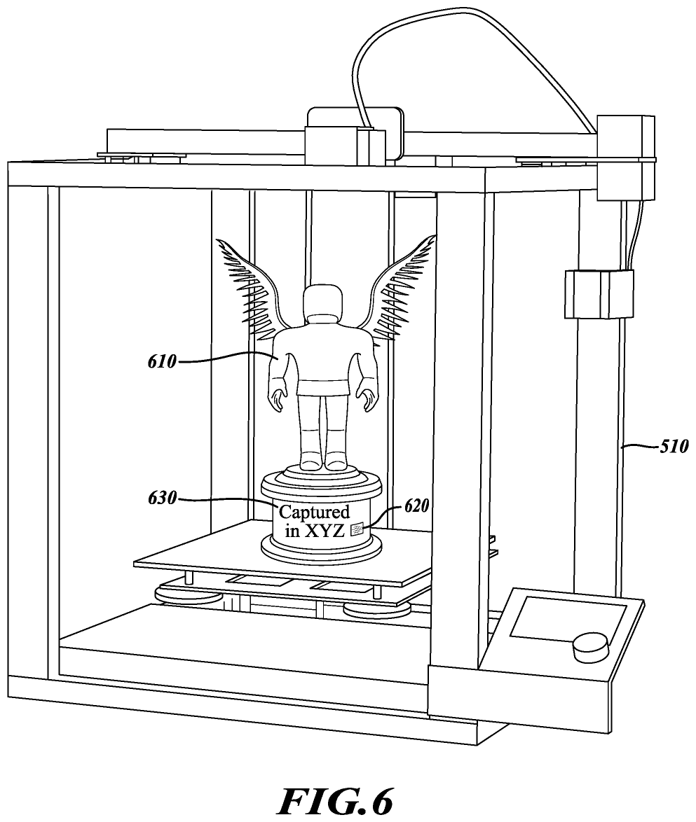

Referring now to FIGS. 5 and 6, an embodiment of a system for increasing user-engagement with underlying content is shown in which a 3D printer file 502 of the virtual engagement content 120 is sent to a 3D printer 510 to be printed. In many legacy systems where a user is able to acquire a digital item, the user is only able to keep the digital item in a virtual environment. However, in embodiments of the system and method for increasing user-engagement with underlying content, the user is able to send the captured virtual engagement content 120 to be 3D printed and saved in the real world outside of the virtual environment in which it was captured. This enables the user to have captured virtual engagement content 120 on display in the real world that is secure from cyber-hackers that might steal or otherwise delete the virtual engagement content. This also enables the user to display a trophy cabinet of captured virtual engagement content 120 in the real world that is protected from a computer system crash of the user's computer system.

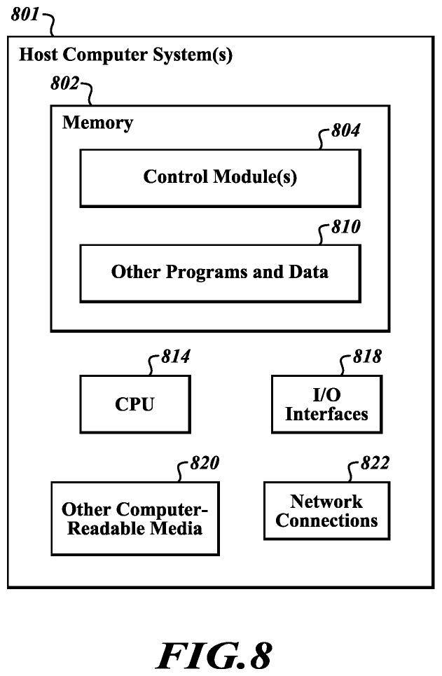

The 3D printing of virtual engagement content 120 may be used to safeguard against loss by account hacking or computer storage failure. In some embodiments, as shown in FIG. 8, the computer system 801 includes a processor 814 and a memory 802 that is arranged to store computer instructions. The computer instructions are executable by the processor 814. In some embodiments, the computer instructions cause the processor 814 to enable a user to capture a virtual engagement content while watching underlying linear streaming television and/or on-demand content. Referring again to FIGS. 5 and 6, the system is configured to receive a request from the user to 3D print the virtual engagement content 120. Further, the system is configured to communicate with a server that stores the virtual engagement content 120. The system then prepares a 3D printer file 502 of the virtual engagement content 120 requested by the user. Notably, the system employs technology, such as digital rights management, to prevent duplication of the 3D printer file 502 of the virtual engagement content 120 requested by the user.

In some embodiments, the system sends the 3D printer file 502 of the virtual engagement content 120 to a 3D printer 510 to be printed. In a subset of those embodiments, the system sends the 3D printer file 502 of the virtual engagement content 120 to a 3D printer 510 that is part of the same system to be printed. In another subset of those embodiments, the system sends the 3D printer file 502 of the virtual engagement content 120 to a 3D printer 510 that is part of a third party system to be printed. In still another subset of those embodiments, the system sends the 3D printer file 502 of the virtual engagement content 120 to a 3D printer 510 that is owned by the user to be printed.

As shown in FIG. 6, in one embodiment of the system for increasing user-engagement with underlying content, the 3D printing system has generated a 3D printed tangible physical item 610 from the 3D printer file of the virtual engagement content 120, regardless of the location or the ownership of the 3D printer. Moreover, in some embodiments of the system for increasing user-engagement with underlying content, which includes a 3D printing system for virtual engagement content 120, the system for increasing user-engagement with underlying content validates the authenticity of transformation of the virtual engagement content 120 into the 3D printed tangible physical item 610. In some such embodiments, the system validates the authenticity of transformation by creating a non-fungible token of the virtual engagement content 120 that is associated with the 3D printed tangible physical item 610.

Additionally, in another aspect of some embodiments, the virtual engagement content 120 is tradeable as non-fungible tokens that specify if there are any 3D prints of the virtual item still available or if the non-fungible token is now “only” a virtual non-fungible token. Once traded in the marketplace, the non-fungible token then appears in the new owner's “trophy” room with or without the real world 3D printability associated with it.

In still another aspect of some embodiments, the 3D printed tangible physical item 610 is printed with a bar code 620, such as a QR code, any of type of bar code, whether a matrix bar code, a one, two, or three dimensional bar code, or other unique code that when scanned shows the current ownership of the non-fungible token associated with the 3D printed tangible physical item 610 as well as provides a link to the details of the underlying content 110 that was being displayed when the virtual engagement content 120 was captured. Thus, the term, bar code, or QR code is used herein in the broadest sense to include any of these computer readable codes that are printed, displayed, shown on a screen, or the like. In some embodiments, one or more of the date, time, name of the player, and other relevant information 630 related to the capture of the virtual engagement content 120 by the user is shown on the 3D printed virtual engagement content 610.

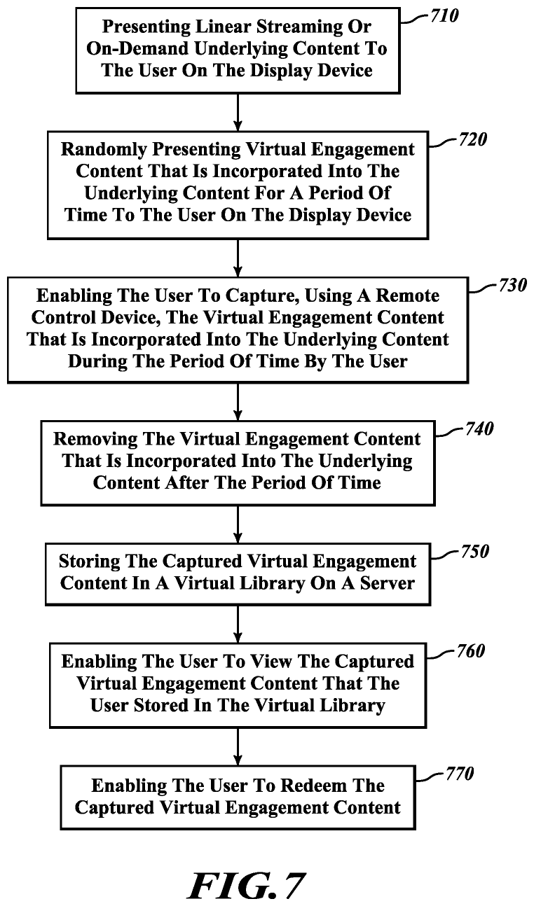

FIG. 7 is a logic diagram showing a method for increasing user-engagement with underlying content (e.g., one or more of television and movie programming) being viewed by a user on a display device. As shown in FIG. 7, at operation 710, the method includes presenting linear streaming or on-demand underlying content 110 to the user on the display device 130. At operation 720, the method includes randomly presenting virtual engagement content 120 that is incorporated into the underlying content 110 for a period of time to the user on the display device 130. At operation 730, the method includes enabling the user to capture, using a remote control device, the virtual engagement content 120 that is incorporated into the underlying content 110 during the period of time. At operation 740, the method includes removing the virtual engagement content 120 that is incorporated into the underlying content 110 after the period of time. At operation 750, the method includes storing the captured virtual engagement content 120 in a virtual library on a server. At operation 760, the method includes enabling the user to view the captured virtual engagement content 120 the user stored in the virtual library on the server. At operation 770, the method includes enabling the user to redeem the captured virtual engagement content 120.

FIG. 8 shows a system diagram that describes an example implementation of a computing system(s) for implementing embodiments described herein. The functionality described herein for a system for increasing user-engagement with underlying content by inserting virtual engagement content, can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that it is agnostic to the underlying cloud infrastructure, allowing higher deployment agility and flexibility.

In particular, shown is an example server or host computer system(s) 801. In some embodiments, one or more special-purpose computing systems may be used to implement the functionality described herein. Accordingly, various embodiments described herein may be implemented in software, hardware, firmware, or in some combination thereof. Host computer system(s) 801 may include memory 802, one or more central processing units (CPUs) 814, I/O interfaces 818, other computer-readable media 820, and network connections 822.

Memory 802 may include one or more various types of non-volatile and/or volatile storage technologies. Examples of memory 802 may include, but are not limited to, flash memory, hard disk drives, optical drives, solid-state drives, various types of random-access memory (RAM), various types of read-only memory (ROM), other computer-readable storage media (also referred to as processor-readable storage media), or the like, or any combination thereof. Memory 802 may be utilized to store information, including computer-readable instructions that are utilized by CPU 814 to perform actions, including those of embodiments described herein.

Memory 802 may have stored thereon control module(s) 804. The control module(s) 804 may be configured to implement and/or perform some or all of the functions of the systems, components and modules described herein for a system for increasing user-engagement with underlying content by inserting virtual engagement content. Memory 802 may also store other programs and data 810, which may include rules, databases, application programming interfaces (APIs), software platforms, cloud computing service software, network management software, network orchestrator software, network functions (NF), AI or ML programs or models to perform the functionality described herein, user interfaces, operating systems, other network management functions, other NFs, etc.

Network connections 822 are configured to communicate with other computing devices to facilitate the functionality described herein. In various embodiments, the network connections 822 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 818 may include a video interface, other data input or output interfaces, or the like. Other computer-readable media 820 may include other types of stationary or removable computer-readable media, such as removable flash drives, external hard drives, or the like.

Some methods, functions, steps, or features have been described as being executed by corresponding software by a processor. It is understood that any methods, functions, steps, features, or anything related to the systems disclosed herein may be implemented by hardware, software (e.g., firmware), or circuits despite certain methods, functions, steps, or features having been described herein with reference to software corresponding thereto that is executable by a processor to achieve the desired method, function, or step. It is understood that software instructions may reside on a non-transitory medium such as one or more memories accessible to one or more processors in the systems disclosed herein. For example, where a computing device receives data, it is understood that the computing device processes that data whether processing the data is affirmatively stated or not. Processing the data may include storing the received data, analyzing the received data, and/or processing the data to achieve the desired result, function, method, or step. It is further understood that input data from one computing device or system may be considered output data from another computing device or system, and vice versa. It is yet further understood that any methods, functions, steps, features, results, or anything related to the systems disclosed herein may be represented by data that may be stored on one or more memories, processed by one or more computing devices, received by one or more computing devices, transmitted by one or more computing devices, and the like.

The foregoing description, for purposes of explanation, uses specific nomenclature and formula to provide a thorough understanding of the disclosed embodiments. It should be apparent to those of skill in the art that the specific details are not required in order to practice the disclosure. The embodiments have been chosen and described to best explain the principles of the disclosed embodiments and their practical application, thereby enabling others of skill in the art to utilize the disclosed embodiments, and various embodiments with various modifications as are suited to the particular use contemplated. Thus, the foregoing disclosure is not intended to be exhaustive or to limit the disclosure to the precise forms disclosed, and those of skill in the art recognize that many modifications and variations are possible in view of the above teachings.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the breadth and scope of a disclosed embodiment should not be limited by any of the above described exemplary embodiments, but should be defined only in accordance with the following claims and their equivalents.

1. A system for increasing user-engagement with underlying content being viewed by a user on a display device, the system comprising:
a memory arranged to store computer instructions, the computer instructions executable by one or more processors that cause the system to:
present underlying content to the user on the display device;
randomly present virtual engagement content that is incorporated into the underlying content for a period of time to the user on the display device;
enable the user to capture, using a remote control device, the virtual engagement content that is incorporated into the underlying content during the period of time;
remove the virtual engagement content from being incorporated into the underlying content after the period of time;
store the captured virtual engagement content in a virtual library;
enable the user to view the captured virtual engagement content the user stored in the virtual library on the server; and
enable the user to redeem the captured virtual engagement content.

2. The system of claim 1, wherein the virtual engagement content is captured by using a fixed button press on the remote control device.

3. The system of claim 1, wherein the virtual engagement content is captured by using a button press on the remote control device that is specific to the virtual engagement content being captured.

4. The system of claim 1, wherein the virtual engagement content is presented at random locations on the display device.

5. The system of claim 1, wherein the underlying content is one or more of television and movie programming content.

6. The system of claim 1, wherein the system creates a non-fungible token associated with the virtual engagement content that enables the virtual engagement content to be one or more of traded, sold, and purchased.

7. The system of claim 1, wherein the memory further includes additional computer instructions, that when executed by the one or more processors, cause the system to:
receive a request from the user to 3D print the virtual engagement content;
communicate with a server that stores the virtual engagement content that was captured by the user during display of the underlying content;
prepare a 3D printer file of the virtual engagement content requested by the user;
prevent duplication of the 3D printer file of the virtual engagement content requested by the user;
send the 3D printer file of the virtual engagement content to a 3D printer to be printed; and
validate authenticity of transformation of the virtual engagement content into a 3D printed tangible physical item.

8. The system of claim 7, wherein the system creates a non-fungible token associated with the 3D printed tangible physical item that enables the 3D printed tangible physical item to be one or more of traded, sold, and purchased.

9. The system of claim 8, wherein the 3D printed tangible physical item is printed with a bar code that when scanned shows the current ownership of the non-fungible token associated with the 3D printed tangible physical item.

10. A method for increasing user-engagement with underlying content being viewed by a user on a display device, the method comprising:
presenting underlying content to the user on the display device;
randomly presenting virtual engagement content that is incorporated into the underlying content for a period of time to the user on the display device;
enabling the user to capture, using a remote control device, the virtual engagement content that is incorporated into the underlying content during the period of time;
removing the virtual engagement content that is incorporated into the underlying content after the period of time;
storing the captured virtual engagement content in a virtual library; and
enabling the user to view the captured virtual engagement content the user stored in the virtual library on the server.

11. The method of claim 10, wherein the virtual engagement content is captured by using a fixed button press on the remote control device.

12. The method of claim 10, wherein the virtual engagement content is captured by using a button press on the remote control device that is specific to the virtual engagement content being captured.

13. The method of claim 10, wherein the virtual engagement content is presented at random locations on the display device.

14. The method of claim 10, wherein the underlying content is one or more of television and movie programming content.

15. The method of claim 10, further comprising:
creating a non-fungible token associated with the virtual engagement content that enables the virtual engagement content to be one or more of traded, sold, and purchased.

16. The method of claim 10, further comprising:
receiving a request from the user to 3D print the virtual engagement content;
communicating with a server that stores the virtual engagement content that was captured by the user during display of the underlying content;
preparing a 3D printer file of the virtual engagement content requested by the user;
preventing duplication of the 3D printer file of the virtual engagement content requested by the user;
sending the 3D printer file of the virtual engagement content to a 3D printer to be printed; and
validating authenticity of transformation of the virtual engagement content into a 3D printed tangible physical item.

17. The method of claim 16, further comprising:
creating a non-fungible token associated with the 3D printed tangible physical item that enables the 3D printed tangible physical item to be one or more of traded, sold, and purchased.

18. The method of claim 17, further comprising:
printing the 3D printed tangible physical item with a bar code that when scanned shows the current ownership of the non-fungible token associated with the 3D printed tangible physical item.

19. A non-transitory computer-readable storage medium having computer-executable instructions stored thereon that, when executed by at least one processor, cause the at least one processor to cause operations to be performed, the operations including:
presenting underlying content to a user on a display device;
randomly presenting virtual engagement content that is incorporated into the underlying content for a period of time to the user on the display device;
enabling the user to capture, using a remote control device, the virtual engagement content that is incorporated into the underlying content during the period of time;
removing the virtual engagement content that is incorporated into the underlying content after the period of time;
storing the captured virtual engagement content in a virtual library; and
enabling the user to view the captured virtual engagement content the user stored in the virtual library on the server.

20. The non-transitory computer-readable storage medium of claim 19, wherein the non-transitory computer-readable storage medium further causes the processor to perform the operation of:
creating a non-fungible token associated with a 3D printed tangible physical item that enables the 3D printed tangible physical item to be one or more of traded, sold, and purchased.
